(19) United States
(12) Patent Application Publication
(10) Pub. No.: US 2008/0094725 A1
(43) Pub. Date: Apr. 24, 2008

(54) METHOD FOR BRINGING TOGETHER AT LEAST TWO PREDETERMINED QUANTITIES OF FLUID AND/OR GAS

(75) Inventor: Johannus Wilhelmus Weekamp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,297

(22) PCT Filed: Jul. 26, 2005
(86) PCT No.: PCT/IB05/52507

§ 371 Date: Feb. 6, 2007

(30) Foreign Application Priority Data
Aug. 9, 2004 (EP) 04103828.2

(51) Int. Cl. G02B 1/06; B29D 11/00; F17D 1/08

(52) U.S. Cl. 359/666; 264/1.7; 137/3

(57) ABSTRACT

PT4NT,040X60 In a process of manufacturing a variable focus lens package, two lens package portions (10, 20) are applied. Each lens package portion comprises a body part (11, 21) and a cover (12, 22), and two filling holes (13, 23) extending through the lens package portion. Furthermore, each body part comprises a central hole (14, 24). In a filling position, the lens package portions contact each other, and fluids (30, 40) are supplied to the central holes of the lens package portions, through filling holes of the opposite lens package portion. Subsequently, the lens package portions are displaced with respect to each other, until the central holes are aligned. In the process, predetermined quantities of the fluids are obtained in the central holes, while superfluous quantities of the fluids remain in the filling holes. Furthermore, the contact between the lens package portions is sealed by means of a lubricant applied between the lens package portions.

Method for bringing together at least two predetermined quantities of fluid and/or gas The present invention relates to a method for bringing together at least two predetermined quantities of matter, in particular fluid and/or gaseous matter.

The need for such a method is present in various fields. For example, the method may be applied during a process of analyzing samples in a medical laboratory. In the field of medical analysis, for the purpose of bringing together predetermined quantities of fluids, many machines and instruments have been developed. In many cases, predetermined quantities of fluid are manually measured off by an analyst, for example by applying a pipette.

Another field in which a method as defined in the first paragraph is applied, is the field of variable focus lens packages. In general, a variable focus lens package comprises a predetermined quantity of an electrically insulating fluid and a predetermined quantity of an electrically conducting fluid. These quantities of fluid are non-miscible, wherein these quantities of fluid contact each other over a meniscus. Functionally, the fluids have different indices of refraction. The variable focus lens comprises a fluid chamber for containing the quantities of fluid. In many cases, the fluid chamber is formed as a through-hole in a body, of which both ends are closed off by means of a cover.

For the purpose of a proper functioning of the variable focus lens package, it is very important that the quantities of the electrically insulating fluid and the electrically conducting fluid match predetermined standard quantities. Therefore, during a manufacturing process of the variable focus lens package, one of the quantities of the fluids is accurately measured off and supplied to the fluid chamber, after which the remaining space is filled with the other of the quantities of the fluids.

It is an objective of the present invention to provide a method for bringing together at least two predetermined quantities of matter, in particular fluid and/or gaseous matter, by which the process of measuring off of the predetermined quantities is simplified, while maintaining a high level of accuracy. The objective is achieved by a method, comprising the following steps:
providing at least two carriers, wherein each carrier comprises at least one containing unit for receiving and containing one of the predetermined quantities of matter, and wherein each carrier comprises at least one contact surface for contacting a contact surface of another carrier;
establishing contact between the contact surfaces of adjacent carriers;
filling the containing units of the carriers with the appropriate matter; and
displacing the carriers with respect to each other while maintaining contact between the contact surfaces of adjacent carriers, wherein an open connection between adjacent containing units is established.

According to an important aspect of the present invention, carriers having containing units for receiving and containing predetermined quantities of matter are applied. The containing units may be formed as recesses in the carriers, for example. By filling the containing units with matter, the predetermined quantities of matter are obtained. Naturally, the dimensions of the containing units are adapted to the volume of the predetermined quantities of matter. By means of a displacement of the carriers with respect to each other, an open connection between adjacent containing units is established, whereby the quantities of matter contained by the containing units are brought together. Throughout the process, the carriers contact each other through contact surfaces, so that the quantities of matter remain inside the containing units. Even during the displacement of the carriers with respect to each other, contact between the contact surfaces of the carriers is maintained. Hence, the displacement of the carriers with respect to each other may be realized by a process in which one carrier slides over another carrier.

The carriers may for example be shaped as discs, which can be put on top of each other. For example, in case two quantities of fluids need to be brought together, two disc-shaped carriers may be applied, wherein each carrier comprises a recess. The carriers are placed on top of each other and the recesses in the carriers are filled with the appropriate fluids. For the purpose of filling the recesses, the carriers may be provided with a through-hole, such that in an initial mutual position, the through-hole of one carrier provides access to the recess of another carrier. When the recesses are filled, the carriers are displaced with respect to each other, wherein the recesses get cut off from the through-holes and get into communication with each other.

In case the method according to the invention is carried out by means of disc-shaped carriers as described in the preceding paragraph, which comprise a through-hole for the purpose of filling the recess of an adjacent carrier, it is important that a distance between the through-hole and the recess in a carrier is chosen such that the recess of an adjacent carrier may be entirely cut off from both the through-hole and the recess. In that way, it is assured that in the adjacent carrier, a quantity of fluid corresponding to the volume of the recess of that carrier is obtained.

Preferably, in order to prevent matter from seeping out between the carriers, a sealing medium is applied to at least one of the contact surfaces of carriers which are intended to come into contact with each other. For example, the sealing medium comprises a lubricant. In such case, the presence of the sealing medium does not only have a sealing effect, but also facilitates the mutual displacement of the carriers.

The carriers may be intended to be used repeatedly, but may also be disposables, dependent of the requirements of possible applications. In such case, the carriers may for example be manufactured from plastic. The carriers may comprise at least two layers, wherein the containing unit may be formed as a through-hole in one of the layers, which is closed off by another of the layers.

It is noted that WO 02/064252 discloses a reaction plate having small indentations and a slidable cover. In the cover, apertures are arranged. A liquid is fed between the reaction plate and the cover when the cover is in a first position, i.e. a position in which the apertures do not overlap the indentations. The indentations are so small that the liquid only flows into the indentations when the cover is moved to a second position in which the apertures at least partly overlap the indentations, due to the fact that in that position, air is allowed to escape from the indentations through the through-holes.

WO 02/064252 does not relate to a method such as the method according to the present invention, i.e. a method for bringing together at least two predetermined quantities of fluid and/or gas. In stead, WO 02/064252 discloses a method for filling small indentations and for preventing evaporation of liquid from the indentations. Therefore, WO 02/064252 does not disclose any particulars of the present invention, such as the fact that at least two carriers are used, wherein each carrier comprises at least one containing unit for containing a predetermined quantity of fluid or gas.

It is another objective of the present invention to facilitate the manufacturing process of variable focus lens packages. The objective is achieved by a method, comprising the following steps:
providing two lens package portions, wherein a first lens package portion comprises a recess for receiving a predetermined quantity of an electrically insulating fluid, wherein a second lens package portion comprises a recess for receiving a predetermined quantity of an electrically conducting fluid, and wherein both lens package portions have a contact surface;
establishing contact between the contact surfaces of the lens package portions;
filling the recess of the first lens package portion with the electrically insulating fluid, and filling the recess of the second lens package portion with the electrically conducting fluid;
displacing the lens package portions with respect to each other while maintaining contact between the contact surfaces of the lens package portions, wherein an open connection between the recesses is established.

According to the present invention, the variable focus lens package is formed on the basis of two lens package portions comprising a recess. During the manufacturing process, the recess of a first lens package portion is filled with the electrically insulating fluid, and the recess of a second lens package portion is filled with the electrically conducting fluid. For the purpose of obtaining the required quantities of these fluids, the volume of the recess of the first lens package portion corresponds to the required quantity of the electrically insulating fluid, and the volume of the recess of the second lens package portion corresponds to the required quantity of the electrically conducting fluid. The lens package portions are placed on top of each other, wherein contact surfaces of the lens package portions contact each other. When the recesses are filled, the lens package portions are shifted with respect to each other, until an open connection between the two recesses is established.

On the basis of the two recesses, the fluid chamber for containing the fluids is obtained. For a proper functioning of the variable focus lens package, it is important that the recesses are aligned, in other words, that central axes of the recesses coincide.

In a suitable embodiment, both lens package portions comprise a through-hole for filling the recess of the other lens package portion. In such case, the recesses are filled when the lens package portions are placed on top of each other in an initial mutual position, wherein an open connection between the recess of the first lens package portion and the through-hole of the second lens package portion and an open connection between the recess of the second lens package portion and the through-hole of the first lens package portion are present. The positions of the through-holes and the recesses are chosen such that during a mutual displacement of the lens package portions, the recess of the first lens package portion gets entirely covered by the contact surface of the second lens package portion, and the recess of the second lens package portion gets entirely covered by the contact surface of the first lens package portion. Superfluous fluids are left in the through-holes and may be collected for the purpose of manufacturing another variable focus lens package.

Closing off of the recesses during mutual displacement of the lens package portions is a very easy way of obtaining the required quantities of the fluids.

It will be clear that it is possible to manufacture an array of variable focus lens packages by providing arrays of lens package portions, filling the recesses in the lens package portions and displacing the arrays of lens package portions with respect to each other. The present invention is not restricted to manufacturing just one variable focus lens package at a time.

The present invention will now be explained in greater detail with reference to the Figures, in which similar parts are indicated by the same reference signs, and in which:

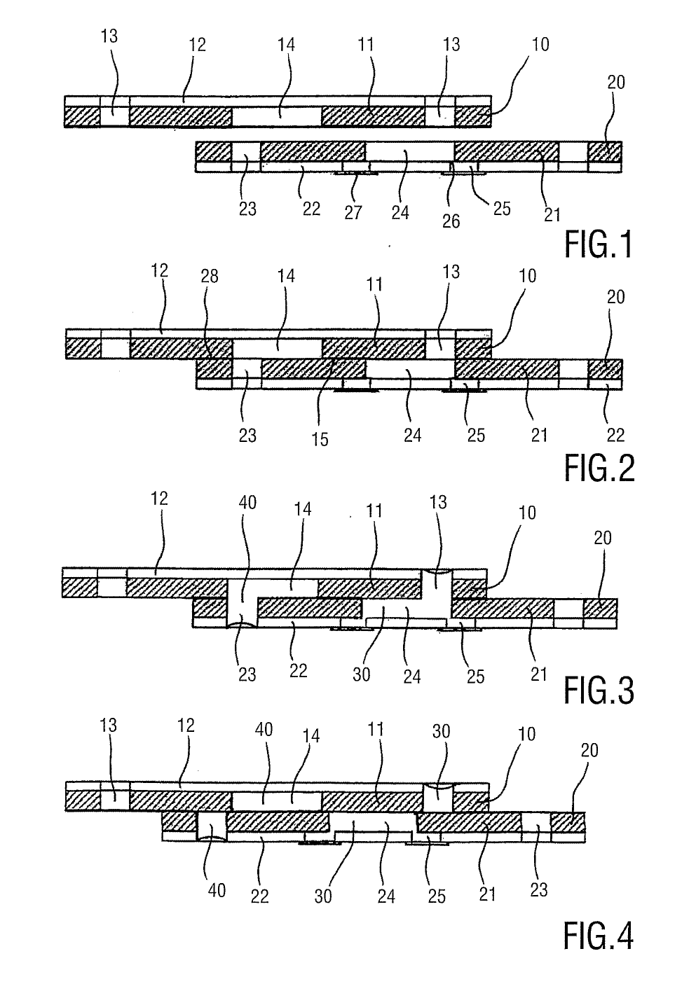

FIGS. 1-6 illustrate steps of a manufacturing process of a variable focus lens package;

FIG. 7 is a sectional view of a portion of the variable focus lens package; and

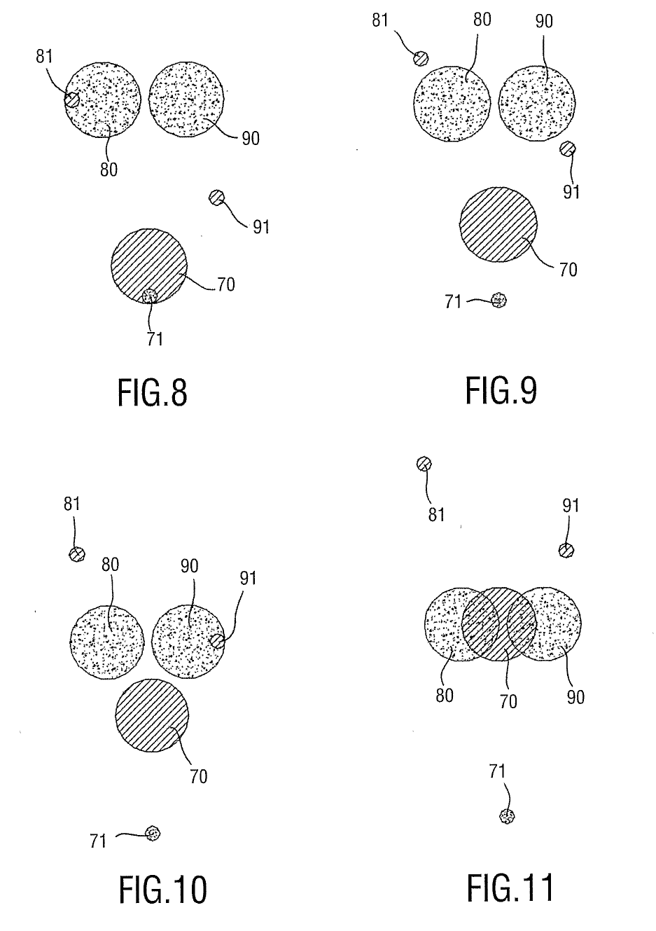

FIGS. 8-11 illustrate steps of a process of bringing together three predetermined quantities of fluid.

FIGS. 1-6 illustrate steps of a manufacturing process of a variable focus lens package 1, which is shown in FIG. 6. In the Figures, a side view of a section of the various components of the variable focus lens package 1 is diagrammatically shown.

In the following, the present invention is described in relation to manufacturing variable focus lens packages, but that does not mean that the present invention is not applicable to manufacturing other optical devices functioning on the basis of the electrowetting effect. A common feature of such devices is that these devices comprise at least one fluid chamber in which two fluid bodies separated by a meniscus are present, in particular a body of an electrically conducting fluid and a body of an electrically insulating fluid. According to the present invention, the optical devices are manufactured by applying two components having recesses for containing the fluids, wherein the components are shifted with respect to each other. Well-known examples of optical devices are a display, a diaphragm, a grating and an optical sensor.

Additionally, the lens package 1 of the invention is also suitable for integration of various elements adjacent to each other. This integration is enabled due to the plate level manufacture and due to the individual filling, which allows that neighbouring elements are filled with different fluids. One option is the provision of two lenses, such as to create a system providing a three-dimensional image. Two lenses, with two image sensors, can be used as well as a module with two cameras for different purposes: for instance one for a distance near to the camera, one for distances far away from the camera. The cameras may even be focussed into opposite directions. Another option is the provision of a lens together with a display.

A first step of the manufacturing process of the variable focus lens package 1 is illustrated by Fig. -1. During this first step, a top lens package portion 10 and a bottom lens package portion 20 are provided. In a suitable embodiment, both lens package portions 10, 20 are made of glass.

The top lens package portion 10 comprises a top body part 11, which is covered by a top cover 12. Both the top body part 11 and the top cover 12 are shaped like discs having a rectangular circumference. In the top lens package portion 10, at positions near the circumference of the top lens package portion 10, two filling holes 13 are arranged, which extend through both the top body part 11 and the top cover 12. Furthermore, in the top body part 11, a central hole 14 is arranged. In the top lens package portion 10, one side of the central hole 14 in the top body part 11 is closed by the top cover 12, whereas another side of the central hole 14 is open.

The bottom lens package portion 20 comprises a bottom body part 21, which is covered by a bottom cover 22. Like the top body part 11 and the top cover 12, the bottom body part 21 and the bottom cover 22 are shaped like discs having a rectangular circumference. Furthermore, like the top lens package portion 10, the bottom lens package portion 20 has two filling holes 23, which are arranged near the circumference of the bottom lens package portion 20, and which extend through both the bottom body part 21 and the bottom cover 22.

In the bottom body part 21, a central hole 24 is arranged, whereas in the bottom cover 22, an annular hole 25 is arranged, which has a central position in the bottom cover 22.

At a side where the bottom body part 21 and the bottom cover 22 contact each other, the annular hole 25 is partially closed by the bottom body part 21, wherein a relatively small inner portion of the annular hole 25 is left uncovered by the bottom body part 21. In this way, an open connection between the annular hole 25 in the bottom cover 22 and the central hole 24 in the bottom body part 21 is obtained, through a relatively small annular connection opening 26.

At a side of the bottom cover 22 opposite to the side where the bottom body part 21 and the bottom cover 22 contact each other, the annular hole 25 is closed by means of a resilient annular membrane 27. Preferably, the membrane 27 comprises corrugated metal portions.

A second step of the manufacturing process of the variable focus lens package 1 is illustrated by FIG. 2. During this second step, the top body part 11 of the top lens package portion 10 and the bottom body part 21 of the bottom lens package portion 20 are placed against each other, wherein a contact surface 15 of the top lens package portion 10 contacts a contact surface 28 of the bottom lens package portion 20, and wherein the lens package portions 10, 20 are positioned with respect to each other in a predetermined way. In the following, the predetermined mutual position of the lens package portions 10, 20 will be referred to as filling position.

In the filling position, open connections are present between a filling hole 13 in the top lens package portion 10 and a combination of the central hole 24 in the bottom body part 21 and the annular hole 25 in the bottom cover 22 on the one hand, and between a filling hole 23 in the bottom lens package portion 20 and the central hole 14 in the top body part 11 on the other hand. In the top lens package portion 10, a distance between the central hole 14 of the top body part 11 and a filling hole 13 is at least equal to the diameter of the central hole 24 of the bottom body part 21, and in the bottom lens package portion 20, a distance between the central hole 24 of the bottom body part 21 and a filling hole 23 is at least equal to the diameter of the central hole 14 of the top body part 11, so that it is not possible to have an open connection between the central holes 14, 24 of the body parts 11, 21 in the filling position.

A third step of the manufacturing process of the variable focus lens package 1 is illustrated by FIG. 3. During this third step, the lens package portions 10, 20 are kept in the filling position, and both a space formed by the annular hole 25 in the bottom cover 22, the central hole 24 in the bottom body part 21 and the associated filling hole 13 in the top lens package portion 10 and a space formed by the central hole 14 in the top body part 11 and the associated filling hole 23 in the bottom lens package portion 20 are filled with fluids. In particular, the space formed by the annular hole 25 in the bottom cover 22, the central hole 24 in the bottom body part 21 and the associated filling hole 13 in the top lens package portion 10 is filled with an electrically conducting fluid 30, and the space formed by the central hole 14 in the top body part 11 and the associated filling hole 23 in the bottom lens package portion 20 is filled with an electrically insulating fluid 40.

The electrically conducting fluid 30 may for example comprise water containing a salt solution, and will hereinafter be referred to as “water”. The electrically insulating fluid 40 may for example comprise a silicone oil or an alkane, and will hereinafter be referred to as “oil”. The water 30 and the oil 40 are non-miscible. Functionally, the water 30 and the oil 40 have different indices of refraction. The densities of the water 30 and the oil 40 are preferably equal, so that the operation of the variable focus lens package 1 is not influenced by its orientation, in other words, so that the operation of the lens package 1 is not influenced by gravitational effects between the water 30 and the oil 40.

A fourth step of the manufacturing process of the variable focus lens package 1 is illustrated by FIG. 4. During this fourth step, the lens package portions 10, 20 are displaced with respect to each other. In the process, the top body part 11 of the top lens package portion 10 slides over the bottom body part 21 of the bottom lens package portion 20, wherein contact between the body parts 11, 21 is maintained. In this way, the formation of a space between the body parts 11, 21 in which the water 30 and the oil 40 may flow from the spaces in which these fluids 30, 40 are contained is avoided.

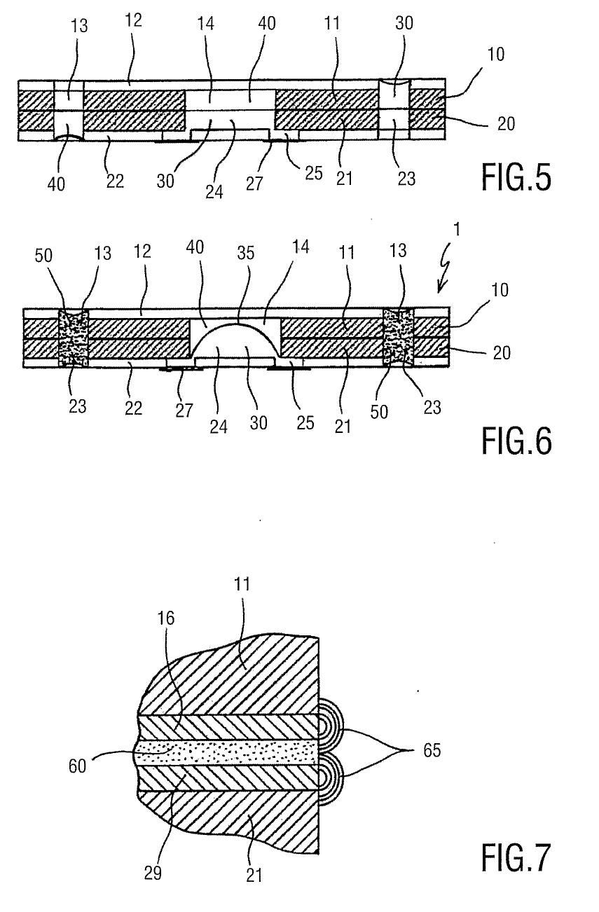

The process of displacing the lens package portions 10, 20 with respect to each other is stopped when the central holes 14, 24 of the body parts 11, 21 are aligned. In the following, the associated mutual position of the lens package portions 10, 20, which is shown in FIGS. 5 and 6, is referred to as final position. In the final position, the filling holes 13, 23 of the package lens portions 10, 20 are also aligned, forming two through-holes through the obtained stack of bottom cover 22, bottom body part 21, top body part 11 and top cover 12.

At a certain point in the process of displacing the lens package portions 10, 20 with respect to each other, before the final position is reached, the central hole 14 in the top body part 11 is completely closed by a portion of the bottom body part 21, and the combination of the central hole 24 in the bottom body part 21 and the annular hole 25 in the bottom cover 22 is completely closed by a portion of the top body part 11. At that point, the earlier connections between a filling hole 23 in the bottom lens package portion 20 and the central hole 14 in the top body part 11, and between a filling hole 13 in the top lens package portion 10 and the combination of the central hole 24 in the bottom body part 21 and the annular hole 25 in the bottom cover 22 are lost. Due to the above-mentioned facts that in the top lens package portion 10, a distance between the central hole 14 of the top body part 11 and a filling hole 13 is at least equal to the diameter of the central hole 24 of the bottom body part 21, and that in the bottom lens package portion 20, a distance between the central hole 24 of the bottom body part 21 and a filling hole 23 is at least equal to the diameter of the central hole 14 of the top body part 11, it is possible to obtain this situation in which sides of the central hole 14 in the top body part 11 and of the combination of the central hole 24 in the bottom body part 21 and the annular hole 25 in the bottom cover 22, which were partially open in the filling position, are completely closed. The associated mutual position of the lens package portions 10, 20 is shown in FIG. 4.

As the situation described in the preceding paragraph occurs when the lens package portions 10, 20 are moved from the filling position to the final position, it is achieved that in the final position, a volume of the water 30 equals a volume of a space defined by the combination of the central hole 24 in the bottom body part 21 and the annular hole 25 in the bottom cover 22, and a volume of the oil 40 equals a volume of a space defined by the central hole 14 in the top body part 11. Consequently, since the volume of the spaces, may be accurately determined, it is possible to have accurate quantities of water 30 and oil 40, while it is not necessary to accurately dose the water 30 and the oil 40.

A fifth step of the manufacturing process of the variable focus lens package 1 is illustrated by FIG. 5. During this fifth step, the lens package portions 10, 20 are held in the final position, while excess quantities of the water 30 and the oil 40, which are present in the filling holes 13, 23 of the lens package portions 10, 20 when the final position is reached, are discharged from the filling holes 13, 23.

A sixth step of the manufacturing process of the variable focus lens package 1 is illustrated by FIG. 6. During this sixth step, a fixating material 50 is introduced in the two through-holes formed by the filling holes 13, 23 in the lens package portions 10, 20. For example, the fixating material comprises epoxy, or a solder, a polymer that is curable with (UV)-radiation or heat. The fixating material can be a solid part that is positioned, possibly anchored and adhered. By means of the fixating material, the lens package portions 10, 20 are fixed in the final position. As soon as the fixation is accomplished, the variable focus lens package 1 is ready.

In the variable focus lens package 1, the central holes 14, 24 of the body parts 11, 21 are joined into one hole. Inside this hole, since the water 30 and the oil 40 are non-miscible, a meniscus 35 is present between the water 30 and the oil 40. During operation of the variable focus lens package 1, this meniscus 35 is used as a lens. For this purpose, the variable focus lens package 1 comprises components, in particular functional layers, additional to the components which are shown in the Figures and described in the above. In the following, for completeness' sake, the operation of a variable focus lens package in general, which is known per se, is explained.

During operation of a variable focus lens package, the shape of the meniscus 35 between the water 30 and the oil 40 is varied under the influence of a voltage. For the purpose of applying a voltage, the variable focus lens package comprises two electrical connectors. A first electrical connector is separated from the water 30, whereas a second electrical connector is in direct contact with the water 30, or is capacitively coupled thereto.

An inner surface of the hole in which the water 30 and the oil 40 are present is covered by a hydrophobic fluid contact layer. When no voltage is applied, the wettability of the fluid contact layer with respect to the oil 40 differs from the wettability of the fluid contact layer with respect to the water 30. Due to an effect referred to as electrowetting, the wettability of the fluid contact layer with respect to the water 30 is variable under the application of a voltage between the first connector and the second connector. A change of the wettability of the fluid contact layer leads to a change of a contact angle of the meniscus 35 at a line of contact between the fluid contact layer and the two fluids 30, 40, whereby the shape of the meniscus 35 is adjusted. Hence, the shape of the meniscus 35 is dependent on the applied voltage, and it is possible to use the meniscus 35 as a variable focus lens.,

It is preferred that the central holes 14, 24 of the body parts 11, 21 are accurately and precisely aligned. However, this may not always be possible, due to inaccuracies in manufacturing or assembly and/or due to the chosen form of the holes. In one embodiment, the diameters of the central holes 14, 24 are not equal to each other. One of the central holes is for instance cone-shaped with a diameter that increases towards the interface with the other central hole. The other central hole is cylindrical, and its diameter is smaller than the diameter of the cone-shaped hole at the interface. This local increase of the diameter enhances the optical power of the lens. Such enhancement is particularly important for zoom applications.

If an interruption will be obtained, the optical effect may be corrected by means of software. The interruption will be located at the boundary, and will correspond to a certain driving voltage. A proper and sharp picture may then be obtained, at such driving voltage, by interpolating, in the image sensor, the images obtained from neighbouring driving voltages.

In the variable focus lens package, variation of the volume of the fluids 30, 40 may occur, for example under the influence of the temperature. If the variation of the volume of the fluids 30, 40 is not compensated for, air bubbles may be formed in the fluids 30, 40, or breaking of the covers 12, 22 may occur, as a result of which the variable focus lens package can not be used anymore. In the variable focus lens package 1 shown in FIG. 6, variation of the volume of the fluids 30, 40 is compensated for by means of the membrane 27. Other expansion correctors could be used alternatively or additionally. One such alternative is an additional chamber in the package that is suitably connected to the main hole. The membrane is however the preferred embodiment, as it is reversible and can be suitably made, such as described in the non-prepublished application PCT IB2004/050614 (PHNL040233). The description of this membrane manufacture is included herein by reference.

According to an important aspect of the present invention, in order to ensure that there is no formation of space between the body parts 11, 21 when the lens package portions 10, 20 are shifted over each other, lubricant is applied to at least one of the contact surface 15 of the top body part 11 and the contact surface 28 of the bottom body part 21. For example, the contact surface 28 of the bottom body part 21 is provided with a thin layer of grease before the bottom body part 21 is put into contact with the contact surface 15 of the top body part 11. The application of a lubricant is very advantageous. In the first place, leakage of water 30 and/or oil 40 between the body parts 11, 21 is prevented. In the second place, it is not possible for air to enter the fluids 30, 40. In the third place, the lubricant is sticky and helps in keeping the lens package portions 10, 20 together. In the fourth place, it is easier to displace the lens package portions 10, 20 with respect to each other when lubricant is present between these portions 10, 20.

In order to obtain a hermetic sealing of the two lens package portions 10, 20 and expel the risk of leakage between the two lens package portions 10, 20, a special sealing technique may be applied, in which galvanic sealing layers are formed on the basis of a solution containing metal salts. For this purpose, it is important that a metal layer is applied to both body parts 11, 21, at the sides where the body parts 11, 21 are intended to contact each other. In the variable focus lens package 1 formed with the body parts 11, 21 and the metal layers, the lubricant is enclosed between the metal layers. At the circumference, galvanic sealing layers are formed on the metal layers when the metal layers are brought into contact with the solution containing metal salts. In the process, for the purpose of realizing the formation of the galvanic sealing layers, an electric current may be applied, or alternatively, another metal acting as a nucleus for stimulating the decomposition of the metal salts may be applied. As soon as the sealing layers of the metal layers contact each other, a hermetic sealing is obtained of the space where the lubricant is. In FIG. 7, the obtained appearance of a portion of the variable focus lens package 1 near the circumference is diagrammatically shown. In the Figure, a metal layer on the top body part 11 is indicated by reference numeral 16, a metal layer on the bottom body part 21 is indicated by reference numeral 29, the lubricant is indicated by reference numeral 60, and the galvanic sealing layers are indicated by reference numeral 65. As an alternative to galvanic processes use can be made of electroless processes.

In spite of the fact that the application of a lubricant as a sealing medium between the contact surfaces 15, 28 of the body parts 11, 21 has many advantages, other options exist within the scope of the present invention. For example, it is possible that both body parts 11, 21 comprise a coating adapted to the purpose of sealing the contact between the body parts 11, 21. Additionally, or alternatively, mechanical means can be provided to assist in the movement of the contact surfaces, for instance to limit movement to a single direction only. In case the step of applying a sealing medium is omitted, it is still possible to use the sealing technique for applying galvanic sealing layers.

Preferably, an array of variable focus lens packages 1 is manufactured simultaneously. It will be clear that it is possible to manufacture such an array of variable focus lens packages 1 by providing arrays of lens package portions 10, 20, supplying the water 30 and the oil 40, and displacing the arrays of lens package portions 10, 20 with respect to each other. When the lens package portions 10, 20 are in the final position, the obtained array of variable focus lens packages 1 may be cut in order to obtain individual variable focus lens packages 1.

The variable focus lens package 1 may be applied in hand-held apparatus, as part of cameras for instance for mobile phones, and in optical scanning devices for use in digital recording equipment or lithography.

A number of variable focus lens packages 1 may be positioned in a row, wherein the fluid chambers of the lens packages 1 containing the water 30 and the oil 40 are aligned with respect to each other, in order to create a zoom lens. It is preferred in that case that the central holes 14, 24 of the body parts 11, 21 do not have an equal diameter in that case, but one is cylindrical and the other is conically shaped.

Instead of two variable focus lens packages in a row, the packages could be integrated. In that event, one of the body parts is a separation between the first lens and the second lens. Filling of the middle part can then be effected, for instance, through filling channels suitably extending to a surface. Alternatively, the filling of the two lenses can be carried out consecutively.

Instead of a zoom lens on the basis of two variable focus packages, a combination could be made on the basis of one variable focus that is tunable on the basis of the electrowetting principle and another variable focus lens that is tunable on the basis of another principle. Such other variable focus lens is for instance a liquid crystalline lens (LC lens). This type of lens can be adequately manufactured as a polymer lens body with the so-called replica techniques, as is for instance described in the non-prepublished application EP 04100449.0 (PHNL040107). The replica technique is applied on plate level on the basis of a glass substrate. In fact, the present lens package and/or each of the body parts 11, 21 is very well suited as this substrate for the application of the replica technique. The provision of the replica layers on one or both of the body parts could occur both before and after filling the variable focus lens package with fluid. Other fixed-focus lenses can be applied with this technique as well, and the technique is moreover suitable for the provision of spacers, (mechanical) alignment marks and the like.

Instead of a zoom lens, two variable focus optical elements can be put in series, that have a different function; a suitable combination is for instance a variable diaphragm and a variable focus lens.

The variable focus lens package 1 according to the present invention is particularly intended for application in a camera, which further comprises an image sensor and an interconnecting body, wherein the interconnecting body comprises electrically conductive tracks arranged on a first surface and a second surface of the interconnecting body, and wherein the electrically conductive tracks are shaped such as to be able to establish a connection between both the image sensor and the lens package 1 to driver electronics therefore, or to contact pads. Besides the application in a camera, other applications of the variable focus lens package 1 are feasible.

The integration with the driver electronics and the image sensor can be achieved in several ways. A first option is the use of a separate housing and carrier. The lens is then embodied as a standard, discrete component that is assembled in a manner known to the skilled person. A second option is the use of the variable focus lens package as the carrier for further components. Use of glass as a carrier is known per se in the electronics industry, particularly from the assembly of liquid crystal displays.

A third option is the combination with a semiconductor device by mutual attachment. Such attachment is suitable done on wafer level. This process is known per se, for instance from WO-A 95/19645 and U.S. Pat. No. 5,504,036, and the combination of a semiconductor wafer with a glass plate is applied on industrial scale for the manufacture of image sensors. This option is preferred, as the assembly costs are drastically reduced and the complete camera module is substantially miniaturized. Moreover, the integration in this manner of lens, image sensor and suitably the driver electronics, allows the provision of an optimised design with short feedbacks. Furthermore, the alignment of the lens to the image sensor can be carried out very precisely, which contributes to the quality of the overall image. The distance between lens and image sensor can be defined adequately with the help of spacers.

It will be clear to a person skilled in the art that the scope of the present invention is not limited to the examples discussed in the foregoing, but that several amendments and modifications thereof are possible without deviating from the scope of the present invention as defined in the attached claims.

For example, at least one of the covers 12, 22 may be shaped as a lens at the position of the respective central hole 14, 24, i.e. at least one of the covers 12, 22 may comprise a convex or a concave surface at this position, so that the variable focus lens package 1 comprises two or three lenses in stead of just one.

In the foregoing, it is stated that the circumference of the disc-shaped lens package portions 10, 20 is rectangular. An advantage of such a shape of the circumference of the lens package portions 10, 20 is that it may be very easily obtained when the variable focus lens package 1 is cut out of an array of variable focus lens packages 1. However, that does not alter the fact that it is possible for the circumference of the lens package portions 10, 20 to have another shape, for example a hexagonal shape or a circular shape.

In the foregoing, a process of manufacturing a variable focus lens package 1 is disclosed, wherein two lens package portions 10, 20 are applied. Each lens package portion 10, 20 comprises a body part 11, 21 and a cover 12, 22, and two filling holes 13, 23 extending through both the body part 11, 21 and the cover 12, 22. Furthermore, each body part 11, 21 comprises a central hole 14, 24.

In a filling position, the lens package portions 10, 20 contact each other, and fluids 30, 40 are supplied to the central holes 14, 24 of the lens package portions 10, 20, through filling holes 13, 23 of the opposite lens package portion 10, 20. Subsequently, the lens package portions 10, 20 are displaced with respect to each other, until the central holes 14, 24 are aligned. In the process, predetermined quantities of the fluids 30, 40 are obtained in the central holes 14, 24, while superfluous quantities of the fluids 30, 40 remain in the filling holes 13, 23. Furthermore, the contact between the lens package portions 10, 20 is sealed by means of a lubricant applied between the lens package portions 10, 20.

During the manufacturing process of the variable focus lens package 1, two lens package portions 10, 20 having holes 13, 14, 23, 24, 25 are provided, wherein the holes 13, 14, 23, 24, 25 have predetermined dimensions and are located at predetermined positions. In a filling position of the lens package portions 10, 20, a portion of the holes is filled with the appropriate fluid, i.e. water 30 or oil 40, after which the lens package portions 10, 20 are displaced with respect to each other until a final position is reached. In the process, predetermined quantities of the fluids 30, 40 are obtained, which are brought together in the final position.

On the basis of the preceding paragraph, it will be understood that a general principle for bringing together predetermined quantities of matter is enclosed in the above-described process of manufacturing the variable focus lens package 1. The lens package portions 10, 20 may be regarded as carriers having a containing unit for receiving and containing a predetermined quantity of matter. In a filling position, the containing units are filled with the appropriate matter. Subsequently, the carriers are displaced with respect to each other, wherein an open connection between the containing units is obtained. In the process, the carriers are in contact with each other over contact surfaces, so that it is not possible for matter to escape between the carriers. Preferably, the carriers are shaped such as to ensure that the predetermined quantities of matter are obtained when the mutual position of the carriers is changed from the filling position to a final position, so that it is not necessary to accurately dose the quantities of matter when the carriers are in the filling position and the containing units are filled.

The general method of bringing together predetermined quantities of matter is not restricted to bringing together just two predetermined quantities of matter. For example, it is possible to bring together a first predetermined quantity of matter and a second predetermined quantity of matter in a first step, and subsequently bringing together the whole of these predetermined quantities of matter and a third predetermined quantity of matter in a second step, wherein both steps are carried out in a similar way. The matter may be a fluid or a gas. In case it is required to form a composition comprising two or more components in a controlled manner, it is possible to fill the containing units of different carriers with the components, and simply bringing the contents of the containing units into contact with each other by displacing the carriers with respect to each other at the moment it is desired to obtain the composition.

It is not necessary that the carriers are disc-shaped like the lens package portions 10, 20 of the variable focus lens package portion 1. Many other shapes of the carriers are possible. For example, in case two carriers are applied, a first carrier may be shaped as a cylinder, wherein a second carrier may be shaped as a tube capable of closely surrounding the first carrier. In such case, the containing units may be positioned such that it takes a rotation of the second carrier with respect to the first carrier about a longitudinal axis to establish an open connection between the containing units. The diameters of the carriers may be constant over their lengths, but the carriers may also have a conical shape.

Like the method for manufacturing the variable focus lens package 1, the general method for bringing together predetermined quantities of matter preferably comprises a step of applying a sealing medium such as a lubricant to at least one of the contact surfaces of adjacent carriers.

It is possible to have a metal membrane like the membrane 27 of the variable focus lens package 1 for closing off one side of at least one of the containing units. In that case, the membrane can be activated to move, whereby a stirring effect is obtained. Furthermore, the membrane can be used for heating up the content of the containing units, wherein each containing unit can have its own temperature time profile. Also, the membrane can be used for applying a voltage to the content of the containing units.

A field in which the general method of bringing together at least two predetermined quantities of matter may be applied is the medical field, in particular the field of molecular diagnostics.

In FIGS. 8-11, steps of a process of bringing together three predetermined quantities of fluid are illustrated. In these Figures, mutual positions of three containing units 70, 80, 90 and three filling holes 71, 81, 91 are shown. A first containing unit 70, a second filling hole 81 and a third filling hole 91 are arranged in a first carrier, and are depicted as being shaded in FIGS. 8-11. As a consequence of the arrangement in one and the same carrier, the first containing unit 70, the second filling hole 81 and the third filling hole 91 have fixed mutual positions. A second containing unit 80, a third containing unit 90 and a first filling hole 71 are arranged in a second carrier, and are depicted as being dotted in FIGS. 8-11. As a consequence of the arrangement in one and the same carrier, the second containing unit 80, the third containing unit 90 and the first filling hole 71 have fixed mutual positions.

In an initial mutual position of the carriers, which is illustrated by FIG. 8, an open connection between the first containing unit 70 and the first filling hole 71 and an open connection between the second containing unit 80 and the second filling hole 81 are established, while the carriers are in close contact with each other over contact surfaces. Preferably, a sealing medium is arranged between the contact surfaces. In the initial mutual position, the first containing unit 70 is filled with a first fluid, through the first filling hole 71, wherein an excess quantity of the first fluid remains in the first filling hole 71, and the second containing unit 80 is filled with a second fluid, through the second filling hole 81, wherein an excess quantity of the second fluid remains in the second filling hole 81.

Starting from the initial mutual position, the carriers are displaced with respect to each other, until a first intermediate mutual position is obtained, in which there are no connections between any of the containing units 70, 80, 90 and the filling holes 71, 81, 91. During the mutual displacement of the carriers, the close contact between the carriers over the contact surfaces is maintained. The first intermediate mutual position is illustrated by FIG. 9. Speaking in terms relating to the graphic representation of FIGS. 8 and 9, the first intermediate mutual position is obtained by holding the second carrier in place and displacing the first carrier in an upward direction.

During the displacement from the initial mutual position to the first intermediate mutual position, the quantities of fluid inside the first containing unit 70 and the second containing unit 80 get cut off from the excess quantities of fluid in the first filling hole 71 and the second filling hole 81, respectively. As a result, a volume of the quantity of the first fluid inside the first containing unit 70 exactly corresponds to a volume of the first containing unit 70, and a volume of the quantity of the second fluid inside the second containing unit 80 exactly corresponds to a volume of the second containing unit 80.

In the first intermediate mutual position, the excess quantities of fluid are removed from the respective filling holes 71, 81. Furthermore, the carriers are cleaned.

Starting from the first intermediate mutual position, the carriers are displaced with respect to each other again, until a second intermediate mutual position is obtained, in which there is only an open connection between the third containing unit 90 and the third filling hole 91. During the mutual displacement of the carriers, the close contact between the carriers over the contact surfaces is maintained. The second intermediate mutual position is illustrated by FIG. 10. Speaking in terms relating to the graphic representation of FIGS. 9 and 10, the second intermediate mutual position is obtained by holding the second carrier in place and displacing the first carrier further in an upward direction.

In the second intermediate mutual position, the third containing unit 90 is filled with a third fluid, through the third filling hole 91, wherein an excess quantity of the third fluid remains in the third filling hole 91.

Starting from the second intermediate mutual position, the carriers are displaced with respect to each other again, until a final mutual position is obtained, in which there is an open connection between the three containing units 70, 80, 90, and wherein the containing units 70, 80, 90 are separated from the filling holes 71, 81, 91. During the mutual displacement of the carriers, the close contact between the carriers over the contact surfaces is maintained. The final mutual position is illustrated by FIG. 11. Speaking in terms relating to the graphic representation of FIGS. 10 and 1 1, the final mutual position is obtained by holding the second carrier in place and displacing the first carrier still further in an upward direction.

During the displacement from the second intermediate mutual position to the final mutual position, the quantity of fluid inside the third containing unit 90 gets cut off from the excess quantity of fluid in the third filling hole 91. As a result, a volume of the quantity of the third fluid inside the third containing unit 90 exactly corresponds to a volume of the third containing unit 90.

In the final mutual position, the excess quantity of the third fluid is removed from the third filling hole 91. Furthermore, in the final mutual position, the three containing units 70, 80, 90 form one cavity enclosed by the carriers, which cavity is filled with predetermined quantities of the first fluid, the second fluid and the third fluid. All that is needed for obtaining the predetermined quantities of fluid and bringing these quantities of fluid together is filling the containing units 70, 80, 90 through their corresponding filling holes 71, 81, 91, at appropriate moments during a process of putting the carriers in successive predetermined mutual positions. Naturally, the mutual positions of the first containing unit 70, the second filling hole 81 and the third filling hole 91 in the first carrier on the one hand and the mutual positions of the second containing unit 80, the third containing unit 90, and the first filling hole 71 in the second carrier on the other hand are adapted to avoiding an establishment of unwanted open connections throughout the process of displacing the carriers with respect to each other.

1. Method for bringing together at least two predetermined quantities of matter (30, 40), in particular fluid and/or gaseous matter, comprising the following steps:
providing at least two carriers (10, 20), wherein each carrier (10, 20) comprises at least one containing unit (14, 24, 25, 70, 80, 90) for receiving and containing one of the predetermined quantities of matter (30, 40), and wherein each carrier (10, 20) comprises at least one contact surface (15, 28) for contacting a contact surface (15, 28) of another carrier (10, 20);
establishing contact between the contact surfaces (15, 28) of adjacent carriers (10, 20);
filling the containing units (14, 24, 25, 70, 80, 90) of the carriers (10, 20) with the appropriate matter (30, 40); and
displacing the carriers (10, 20) with respect to each other while maintaining contact between the contact surfaces (15, 28) of adjacent carriers (10, 20), wherein an open connection between adjacent containing units (14, 24, 25, 70, 80, 90) is established.

2. Method according to claim 1, further comprising the step of applying a sealing medium (60) to at least one of the contact surfaces (15, 28) of carriers (10, 20) which are intended to come into contact with each other.

3. Method according to claim 2, wherein the sealing medium comprises a lubricant (60).

4. Method according to claim 1, wherein the predetermined quantities of matter (30, 40) are obtained by closing off of the containing units (14, 24, 25, 70, 80, 90) by the contact surface (15, 28) of at least one adjacent carrier (10, 20), prior to establishing an open connection between adjacent containing units (14, 24, 25, 70, 80, 90).

5. Method according to claim 1, wherein at least one of the carriers (10, 20) comprises a filling hole (13, 23, 71, 81, 91), through which the matter for filling a containing unit (14, 24, 25, 70, 80, 90) in an adjacent carrier (10, 20) is supplied.

6. Device for bringing together at least two predetermined quantities of matter (30, 40), in particular fluid and/or gaseous matter, comprising:
at least two carriers (10, 20), wherein each carrier (10, 20) comprises at least one containing unit (14, 24, 25, 70, 80, 90) for receiving and containing one of the predetermined quantities of matter (30, 40), and wherein each carrier (10, 20) contacts at least one adjacent carrier (10, 20) over a contact surface (15, 28), and is slidably arranged with respect to this adjacent carrier (10, 20).

7. Device according to claim 6, wherein a volume of each containing unit (14, 24, 25, 70, 80, 90) corresponds to a volume of the predetermined quantity of matter (30, 40) that is to be received and contained in the containing unit (14, 24, 25, 70, 80, 90).

8. Device according to claim, wherein a sealing medium (60) is present between contact surfaces (15, 28) of adjacent carriers (10, 20).

9. Method for manufacturing an optical device such as a variable focus lens package (1), comprising the following steps:
providing two components (10, 20), wherein a first component (10) comprises a recess (14) for receiving a predetermined quantity of an electrically insulating fluid (40), wherein a second component (20) comprises a recess (24, 25) for receiving a predetermined quantity of an electrically conducting fluid (30), and wherein both components (10, 20) have a contact surface (15, 28);
establishing contact between the contact surfaces (15, 28) of the components (10, 20);
filling the recess (14) of the first component (10) with the electrically insulating fluid (40), and filling the recess (24, 25) of the second component (20) with the electrically conducting fluid (30);
displacing the components (10, 20) with respect to each other while maintaining contact between the contact surfaces (15, 28) of the components (10, 20), wherein an open connection between the recesses (14, 24, 25) is established.

10. Method according to claim 9, further comprising the step of applying a sealing medium (60) to at least one of the contact surfaces (15, 28) of the components (10, 20).

11. Method according to claim 10, wherein the sealing medium comprises a lubricant (60).

12. Method according to claim 9, wherein the predetermined quantities of the electrically conducting fluid (30) and the electrically insulating fluid (40) are obtained by closing off of the recesses (14, 24, 25) by the contact surface (15, 28) of the adjacent component (10, 20), prior to establishing an open connection between the recesses (14, 24, 25).

13. Method according to claim 9, wherein the first component (10) comprises a filling hole (13), through which the electrically conducting fluid (30) is supplied to the recess (24, 25) of the second component (20), and wherein the second component (20) comprises a filling hole (23), through which the electrically insulating fluid (40) is supplied to the recess (14) of the first component (10).

14. Method according to claim 9, wherein metal layers (16, 29) are arranged on the contact surfaces (15, 28) of the components (10, 20), and wherein, at a circumference of the optical device, when the open connection between the recesses (14, 24, 25) in the components (10, 20) is obtained, the metal layers (16, 29) are brought into contact with a solution containing metal salts, wherein galvanic sealing layers (65) are formed at the position of the metal layers (16, 29).

15. Optical device such as a variable focus lens package (1), comprising a body in which a through-hole containing a quantity of an electrically conducting fluid (30) and a quantity of an electrically insulating fluid (40) is present, wherein both sides of the through-hole are closed off by means of a cover (12, 22), wherein the body comprises two body parts (11, 21), and wherein a sealing medium (60) is present between surfaces (15, 28) of the body parts (11, 21).

16. Optical device according to claim 15, wherein the sealing medium comprises a lubricant (60).

17. Optical device according to claim 15, wherein metal layers (16, 29) are arranged on the surfaces (15, 28) of the body parts (11, 21), and wherein, at a circumference of the optical device, galvanic sealing layers (65) interconnecting the body parts (11, 21) are present at the position of the metal layers (16, 29).

18. Optical device as claimed in claim 15, wherein a semiconductor device is attached to one of the body parts.

19. Electronic device such as a camera, comprising the optical device according to claim 15.

20. Method for manufacturing an array of optical devices such as a variable focus lens package (1), comprising the following steps:
providing two arrays of package units (10, 20), wherein the package units (10) of a first array comprise a recess (14) for receiving a predetermined quantity of an electrically insulating fluid (40), wherein the package units (20) of a second array comprise a recess (24, 25) for receiving a predetermined quantity of an electrically conducting fluid (30), and wherein both arrays of package units (10, 20) have a contact surface (15, 28);
establishing contact between the contact surfaces (15, 28) of the arrays of package units (10, 20);
filling the recesses (14) of the package units (10) of the first array with the electrically insulating fluid (40), and filling the recesses (24, 25) of the package units (20) of the second array with the electrically conducting fluid (30);
displacing the arrays of package units (10, 20) with respect to each other while maintaining contact between the contact surfaces (15, 28) of the arrays of package units (10, 20), wherein an open connection between the recesses (14, 24, 25) is established.

21. Method according to claim 20, further comprising the step of applying a sealing medium (60) to at least one of the contact surfaces (15, 28) of the arrays of package units (10, 20).
